(19) United States
(12) Patent Application Publication
(10) Pub. No.: US 2009/0304216 A1
(43) Pub. Date: Dec. 10, 2009

(54) RECEIVER IN THE EAR (RITE) COMPONENT FOR A HEARING AID

(75) Inventor: Casper Hojsted Hansen, Horsholm (DK)

Correspondence Address: SUGHRUE MION, PLLC, 2100 PENNSYLVANIA AVENUE, N.W., SUITE 800, WASHINGTON, DC, 20037, US

(73) Assignee: Widex A/S, Varlose (DK)

(21) Appl. No.: 12/537,512

(22) Filed: Aug. 7, 2009

Related U.S. Application Data
(63) Continuation-in-part of application No. PCT/DK2008/050028, filed on Feb. 8, 2008.

(51) Int. Cl. H04R 25/00

(52) U.S. Cl. 381/324

(57) ABSTRACT

A receiver in the ear (RITE) component (1) for a hearing aid, said RITE component comprising a receiver (9) and a receiver housing (3), and a connector (4) comprising coupling means (7) for coupling the RITE component to a BTE housing component of said hearing aid, and said connector (4) comprising an electrically conductive means (6). The RITE component (1) further comprises a fixture (5) to connect the receiver (9) in the receiver housing (3) and the connector (4), said fixture (5) comprising a spring element (15) and at least one contact terminal (16) adapted for abutting contact with at least one corresponding contact terminal (17) on said receiver (9).

### RELATED APPLICATIONS

The present application is a continuation-in-part of application No. PCT/DK2008050028, filed on Feb. 8, 2008, in Denmark and published as WO 2008095505 A1.

The present application is based on and claims priority from PCT/DK2007050016, filed on Feb. 8, 2007 in Denmark, the contents of which are incorporated hereinto by reference. This application is now abandoned.

### BACKGROUND OF THE INVENTION

1. Field of the Invention

The present invention relates generally to hearing aids. The invention more specifically, relates to hearing aid systems of the receiver-in-the-ear (RITE) type, comprising a RITE component, said RITE component comprising a receiver and a receiver housing, and a connector comprising coupling means for coupling the RITE component to a behind-the-ear (BTE) housing component of said hearing aid, and said connector comprising an electrically conductive means. The invention further related to a method of connecting a receiver to a BTE component of a hearing aid.

2. The Prior Art

In traditional BTE hearing aids, the receiver, i.e. the speaker or acoustic output transducer, is located in the BTE housing component. Sound emitted from the receiver in the BTE housing component is then conducted to the ear canal, e.g. to an earplug located there, by a sound conducting tube. As indicated by the name, hearing aids of the RITE type have the receiver located in the ear canal of the user, or at least in the vicinity thereof, thereby avoiding the sound tube and its influence on the sound emitted by the receiver, e.g. attenuation of certain frequencies. Within the context of the present disclosure the part adapted for being placed in the ear canal or in the vilinity thereof, and incorporating a receiver, a receiver housing and a connecting cable, is referred to as a RITE component.

WO-A1-2004/025990 provides a hearing aid system including an earpiece auditory device, which device may be shipped to the user in several different packages, for example one containing an ear mould and another one containing a receiver and a connector already coupled together. Upon receipt the user may assemble the pieces to obtain the hearing aid. Also, disassembly, re-assembly and repair has been made convenient so that the user may repair the device without the need of returning the device for repair. Furthermore WO-A1-2004/025990 discloses the possibility of making the coupling between the ear mould and the main body part a detachable coupling, e.g. by the use of screws.

In such hearing aid systems comprising a RITE component it is known to replace malfunctioning parts by simply replacing the component of the hearing aid (e.g. the RITE component or the BTE housing component) in which the malfunctioning part is located, since this is more convenient and cheaper than actually replacing the specific malfunctioning part (e.g. the receiver), mainly because of the difficulties, and thereby time consumption, associated with disassembling the relevant component to gain access to the specific malfunctioning part.

However, the abovementioned solution presents a significant waste of material and as a consequence unnecessary costs as opposed to replacing the specific malfunctioning part of the hearing aid, especially in the case of a malfunction in the RITE component that is not caused by the receiver, since the receiver is relatively expensive compared to the rest of the RITE component.

The present invention therefore aims at providing a RITE component, comprising a receiver, a receiver housing and a connecting cable means, in which disassembly of the RITE component and thereby replacement of the receiver is made particularly simple, as the time needed to disassemble the RITE component is minimized, thus over-coming the abovementioned drawbacks.

### SUMMARY OF THE INVENTION

The invention, in a first aspect, provides a receiver-in-the-ear (RITE) component for a hearing aid, said RITE component comprising, a receiver, a receiver housing, a connector, said connector having coupling means for coupling to a BTE housing component of said hearing aid, and an electrically conductive means, a fixture to connect the receiver in the receiver housing and the connector, said fixture having a spring element and at least two contact terminals adapted for abutting contact with corresponding contact terminals on said receiver.

Such a RITE component provides the advantage of being easier and cheaper to repair in the case of a malfunctioning receiver, in that it is made particularly easy and quick to disassemble the RITE component and replace the receiver, which in turn results in significant savings in material costs. Furthermore the need for solderings in connection with the contact terminals of the fixture and the receiver is conveniently avoided, which further simplifies the disassembly of the RITE component.

According to a preferred embodiment, said fixture comprises a main body part, and wherein said main body part and said receiver housing comprise respective and mutually engaging locking means adapted to lock said fixture and said receiver housing together. Thereby the RITE component is provided with a secure but particularly easy releasable locking means for locking together the receiver housing and the fixture.

According to a particularly preferred embodiment, said locking means in respect of said main body part comprises projecting means, and wherein said locking means in respect of said receiver housing comprises engagement means adapted for engagement with said projecting means. Thereby it is possible to provide the RITE component with a locking means that not only has the above mentioned advantage, but also takes up very little space in the assembled state.

According to a preferred embodiment said engagement means in respect of said receiver housing comprises at least one through hole between an inner surface of said receiver housing and an outer surface of said receiver housing. Providing said engagement means as a through hole is advantageous from a manufacturing point of view, as cores may be extracted externally during injection moulding.

According to a particularly preferred embodiment said through holes in said receiver housing are located between the inner surface and an outer circumferential indentation adapted to accommodate a receiver sealing. This allows for the easy placement of a receiver sealing adapted to cover and seal said through holes, so as to seal the receiver housing from extraneous substances such as moisture.

In another preferred embodiment said at least one of two contact terminals comprises an elongated contact pin, one end of which being adapted for said abutting contact with a respective receiver terminal, thereby enabling electrical contact between the receiver and the fixture without the need of solderings, while at the same time not occupying too much space, because the receiver contacts may be made flat.

According to a preferred embodiment at least one of said elongated contact pins comprises a spring means, and an outer tubular element adapted for sliding contact with an outer circumferential surface of the elongated contact pin. Such a RITE component provides a supporting structure for said elongated contact pin and said spring means, hence providing a bias between the contact terminals on said receiver and said fixture respectively that always ensures proper electrical contact between the receiver and the rest of the RITE component, and hence the hearing aid.

According to a preferred embodiment said outer tubular element comprises a closed end opposite the end of the contact pin adapted for said abutting contact with the receiver terminal. Hereby the structure supporting said elongated contact pin is improved further.

According to a preferred embodiment said contact pin comprises a flange, and said outer tubular element comprises a narrowing at an end near the end of the contact pin adapted for said abutting contact with the receiver terminal. Thereby the contact pin is prevented from falling out of the outer tubular element.

According to a preferred embodiment said main body part of said fixture is moulded around said outer tubular element of said elongated contact pin. This provides for a fixture of high durability that is particularly simple and cheap to produce.

According to a preferred embodiment said spring means, said outer tubular element and said closed end of said outer tubular element consists of an electrically conductive material. Hereby an improved electrical conductivity of said contact terminal is provided. Preferably said electrically conductive material is the same material as that of the remaining part of the contact terminal.

In another preferred embodiment said receiver housing comprises an open end adapted for the insertion of said fixture in an insertion direction, and wherein said elongated, contact pin extends essentially in parallel with said insertion direction, whereby a stable connection between the receiver and the connector is provided.

In another preferred embodiment said elongated contact pin is embedded in a resilient material adapted for biasing said contact pin into said abutting contact with said receiver terminal. This provides a bias between the contact terminals on said receiver and said fixture respectively that always ensures proper electrical contact between the receiver and the rest of the RITE component, and hence the hearing aid. Moreover the provision of a resilient material is simple as compared to providing dedicated biasing springs or the like.

According to a further preferred embodiment said at least one contact terminals of said fixture comprise gilt nickel silver. Hereby good durability of the contact terminals is ensured, while keeping the material costs down.

Since it, with a RITE component according to the invention, is particularly easy and quick to replace the receiver, it thus becomes possible to avoid having to replace the entire RITE component. This in turn opens a possibility of ensuring a better securing of the RITE component on the BTE housing component, as it is more likely that the RITE component will not have to be separated from the BTE housing component ever, mainly because a defective RITE component will not have to be replaced but can readily be repaired.

Thus, according to a further preferred embodiment said coupling means comprises a contact casing, said contact casing being adapted to interlock with a BTE housing locking means located entirely inside of said BTE housing component. This not only provides the possibility of a particularly secure but still releasable coupling between the RITE component and the BTE housing component, but also allows such a releasable coupling to be provided in an inconspicuous way, viz. within the BTE housing component.

According to a particularly preferred embodiment, said BTE housing locking means comprises a fixation spring, and said contact casing comprises a recess adapted for accommodating said fixation spring. Experience has shown that this is sufficient to minimize the risk of the BTE housing component inadvertently being released form the RITE component, which might cause the BTE housing component to fall to the ground and break, while at the same time providing a readily releasable coupling.

The invention, in a second aspect, provides a hearing aid comprising a RITE component and a BTE housing component, said RITE component comprising A receiver-in-the-ear (RITE) component for a hearing aid, said RITE component comprising, a receiver, a receiver housing, a connector, said connector having coupling means for coupling to a BTE housing component of said hearing aid, and an electrically conductive means, a fixture to connect the receiver in the receiver housing and the connector, said fixture having a spring element and at least two contact terminals adapted for abutting contact with corresponding contact terminals on said receiver.

The invention, in a third aspect, provides a method of connecting a receiver to a Behind-the-Ear (BTE) housing component of a hearing aid of the Receiver-in-the-Ear (RITE) type, comprising providing the receiver with contact terminals, inserting the receiver in a receiver housing, providing a connector with electrically conductive means and with coupling means for coupling to the BTE housing component, providing a fixture with a spring element and at least two contact terminals, connecting the fixture to the connecting element, abutting the fixture contact terminals into contact with the receiver contact terminals, and locking the fixture and the receiver housing together.

### BRIEF DESCRIPTION OF THE DRAWINGS

The invention will now be described in further detail based on a non-limiting exemplary embodiment, and with reference to the drawings. In the drawings,

FIG. 1 illustrates a RITE component according to the present invention in the assembled state;

FIG. 2 illustrates an exploded view of the RITE component according to the present invention, comprising a receiver housing, a receiver sealing, a receiver with contact terminals, a fixture and a coupling means;

FIG. 3 illustrates a cross sectional view through the receiver end of a RITE component according to the present invention in the assembled state;

FIG. 4 illustrates a cross sectional view through the coupling means of a RITE component according to the present invention in the assembled state;

FIG. 5 illustrates a perspective view of a hearing aid according to the present invention comprising a RITE component and a BTE housing component, where the BTE housing component comprises a fixation spring located according to the invention;

FIG. 6 illustrates a hearing aid system according to the present invention;

FIG. 7 illustrates a cross sectional view through the receiver end of another embodiment of a RITE component of the present invention in the assembled state; and

FIG. 8 illustrates a cross sectional view of a contact terminal according to the embodiment shown in FIG. 7.

### DETAILED DESCRIPTION OF THE INVENTION

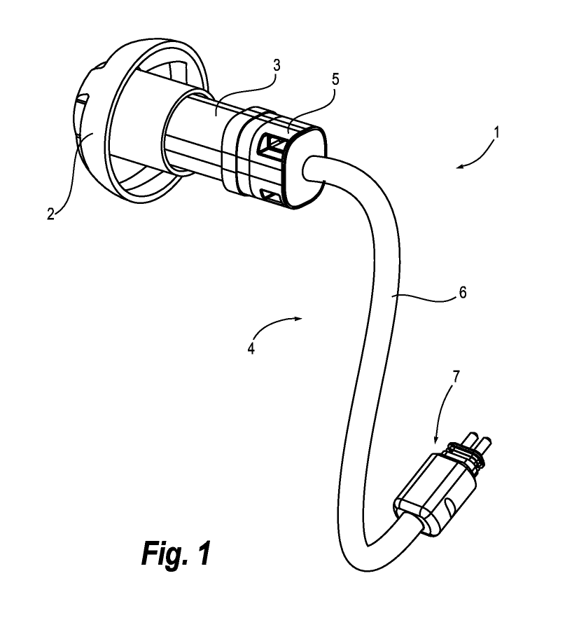

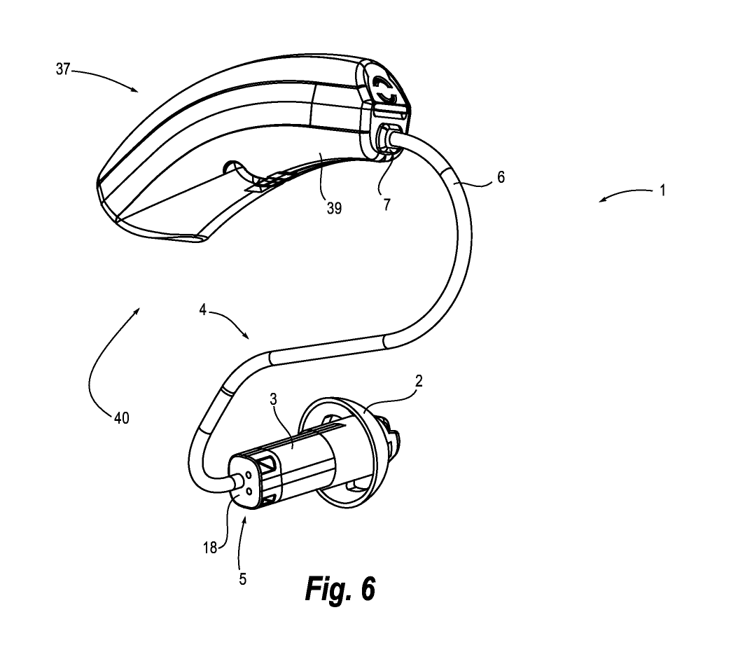

FIG. 1 illustrates a preferred embodiment of a RITE component 1 according to an embodiment of the present invention with an earplug 2 attached. The earplug 2 is a separate piece and does not form part of the RITE component 1 as such. The RITE component 1 comprises a receiver housing 3 and a connector 4, which, in the assembled state shown in FIG. 1, is locked together with the receiver housing 3. The connector 4 serves to electrically connect the sound producing parts of the RITE component 1 with a BTE housing component 37, cf. FIG. 6. For this purpose the connector 4 comprises a fixture 5, an electrically conductive means 6 and a coupling means 7 for coupling the RITE component 1 to the BTE housing component 37.

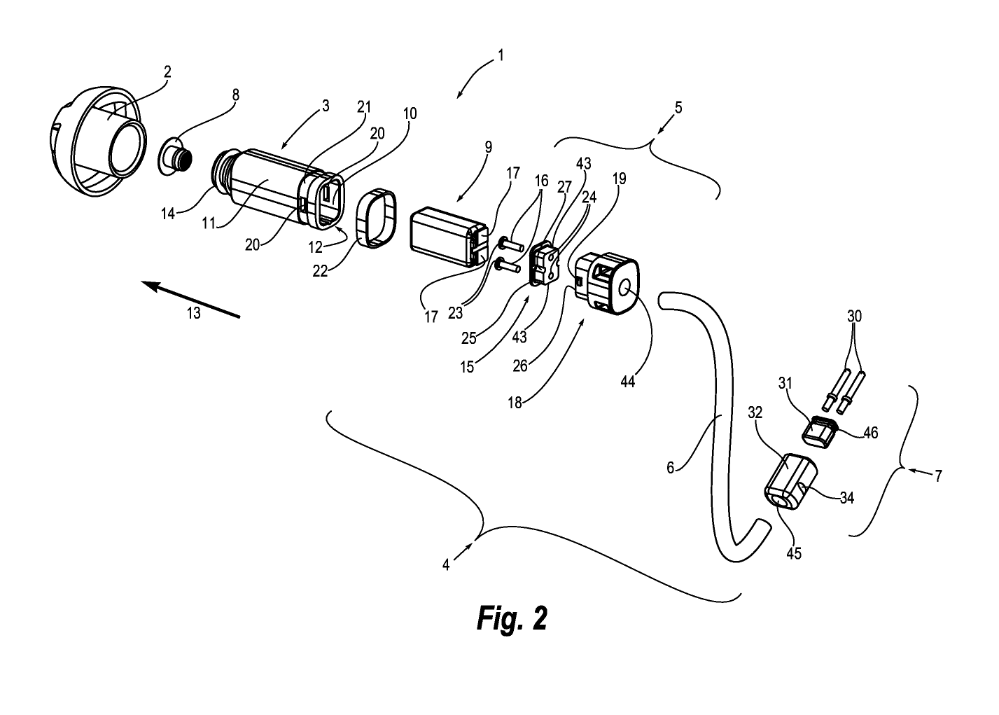

As can be seen from FIG. 2, showing an exploded view of the preferred embodiment of the RITE component 1, the RITE component 1 inside the receiver housing 3 includes a receiver 9. The receiver housing 3 is preferably made by injection moulding of a hard type of polymer and it may be of any shape suitable for accommodating the receiver 9. The receiver housing 3 comprises an inner surface 10, an outer surface 11 and an open end 12 adapted for the insertion of the fixture 5 of a connector 4, in an insertion direction indicated by arrow 13 in FIG. 2. Furthermore the receiver housing 3 comprises a fastening means 14 adapted to accommodate an earwax guard 8 and the earplug 2 located opposite the open end 12. The provision of earwax guards as such, in order to prevent earwax from entering the hearing aid, where it might obstruct the sound output or, even worse, damage the receiver, is well known in hearing aids.

The fixture 5 is provided to connect the receiver 9 in the receiver housing 3 with the connector 4. The fixture 5 comprises a main body part 18, a spring element 15 and at least two contact terminals 16 adapted for abutting contact with at least two corresponding contact terminals 17 on the receiver 9, which may be any standard type of receiver 9, provided the contact terminal 17 on the receiver 9 is substantially flat.

According to a preferred embodiment, the main body part 18 and the receiver housing 3 comprise mutually engaging locking means 19, 20 that are adapted to lock the fixture 5 and the receiver housing 3 together, thereby closing the receiver housing 3 and keeping the receiver 9 in place inside thereof. The main body part 18 and the locking means 19, and similarly the receiver housing 3 and the locking means 20, are preferably each made in one respective piece by injection moulding of a hard type of polymer. The polymer may be any type of hard polymer suitable for ensuring a secure but particularly easy releasable locking means.

However, as shown, in a particularly preferred embodiment, the locking means on the main body part 18 comprises projecting means 19, and the locking means on the receiver housing 3 comprises engagement means 20, whereby the receiver housing 3 and the fixture 5 may be locked together by bringing the projecting means 19 to engage the engagement means 20. Such a configuration is preferred since it provides specific advantages that will be further explained below. As is known by a person skilled in the art, one set of locking means (i.e. one projecting means 19 and one engagement means 20 respectively) is sufficient to provide a secure locking means. However, it is particularly preferred to provide two sets of locking means 19, 20, (i.e. two projecting means 19 and two engagement means 20, respectively) as this configuration ensures an even more secure locking means.

As it will be obvious to a person skilled in the art, the locking means 19, 20 may however also be provided as projecting means on the receiver housing 3 and engagement means on the main body part 18, respectively. Furthermore it is also obvious to a person skilled in the art that more than two sets of locking means 19, 20 may be provided.

In a preferred embodiment, said engagement means in the receiver housing 3 is provided as through holes 20 between the inner surface 10 of the receiver housing 3 and the outer surface 11 of the receiver housing 3. Providing the engagement means in the receiver housing 3 as through holes 20 is advantageous from a manufacturing point of view as it makes injection moulding of the receiver housing 3 considerably easier since cores may be extracted externally during the process.

In a particularly preferred embodiment, said through holes 20 in the receiver housing 3 are located between the inner surface 10 of the receiver housing 3 and an outer circumferential indentation 21 in the receiver housing 3 adapted to accommodate a receiver sealing 22. The receiver sealing 22 is preferably made of a resilient material, thus enabling it to be held firmly in place in the indentation 21 and to completely seal off the holes 20 by its own elastic properties. By placing a receiver sealing 22 to cover the through holes 20 any intrusion of substances, such as moisture from the outside, into the receiver housing is avoided.

As previously mentioned, the fixture 5 comprises at least one contact terminal 16 adapted for abutting contact with at least one corresponding contact terminal 17 on the receiver 9. The at least one contact terminal 16 may be of any suitable electrically conductive material such as copper, silver or iron, but it is particularly preferred that the at least one contact terminal 16 consists of gilt nickel silver.

The contact terminal 16 and the receiver terminal 17 may be provided as contact pins and corresponding female contacts, respectively. However, such a configuration takes up excessive amounts of space and requires solderings on the receiver 9 that may easily break during use of the hearing aid or replacement of the receiver 9.

Therefore, according to a preferred embodiment the at least one contact terminal comprises an elongated contact pin 16, one end 23 of which being adapted for abutting contact with the receiver terminal 17. The use of abutting contact enables the receiver terminals 17 to be constructed as substantially flat terminals 17 made of an electrically conductive material, thereby eliminating the above mentioned drawbacks.

Furthermore, the elongated contact pin 16 extends essentially in parallel with the insertion direction indicated by arrow 13. To further ensure proper and reliable contact between the contact terminal and the receiver terminal 17, the elongated contact pin 16 is embedded in a resilient material adapted for biasing the contact pin 16 into abutting contact with the receiver terminal 17. For this purpose the one end 23 of the contact pins 16 are preferably undercut, such that the resilient material may press on them, thereby creating the bias needed.

According to a preferred embodiment the resilient material is provided in the form of a spring element 15 that is made of a rubber material with the resilience necessary to provide the aforementioned biasing of the contact pin 16.

As shown in FIG. 2, the spring element 15 is preferably provided with a hole 24 that is adapted to accommodate the contact pin 16. According to a particularly preferred embodiment the spring element 15 is provided with two holes 24, as the fixture 5 is correspondingly provided with two contact pins 16, one for each terminal 17 of the receiver 9.

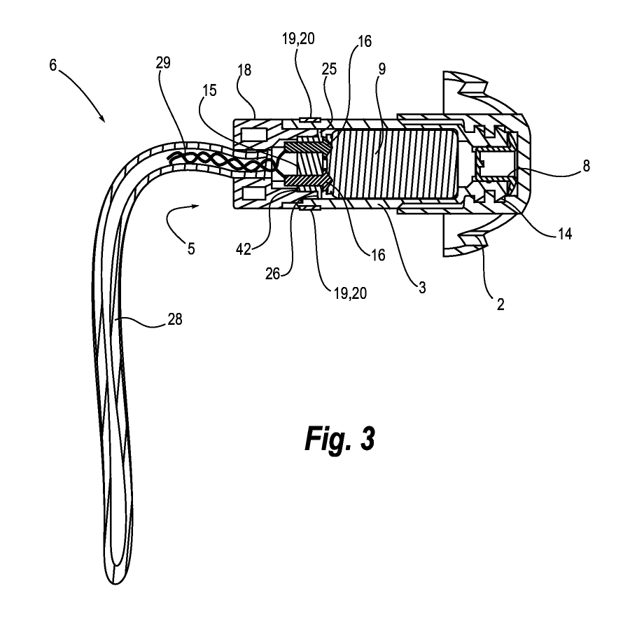

Furthermore, the spring element 15 comprises a collar 25 having one side adapted for abutting contact with an edge 26 of the main body part 18 and another side adapted for abutting contact with the receiver 9. The interior wall of the main body part 18 comprises a ledge 42, shown in FIG. 3, adapted for abutting contact with the outer edges 43 of the side of the spring element 15 opposing the collar 25 whereby the ledge 42 is supporting the spring element 15. The ledge 42 and the collar 25 is provided to in combination ensure that the spring element 15 will not recede into the interior of the main body part 18 by accident, which in turn would disrupt the contact between the contact terminals 16 and the receiver terminal 17.

The spring element 15 may further comprise at least one outer indentation 27 adapted for engagement with a corresponding inner vertical structure on the wall of the main body part 18, thereby further ensuring that the spring element 15 will not dislocate itself inside the main body part 18.

The spring element 15 is mounted in the main body part 18 either unfixed by simply inserting it into the main body part 18 or, which is preferred, fixedly by the use of either a fixing agent (such as glue or the like) or by its own resilience.

The shape of the spring element 15 is however not limited to the above described preferred embodiment, as it may in principle be of any suitable shape that provides the abovementioned features regarding bias and accommodation of the contact terminals 16.

For example, the spring element could alternatively be replaced by coil springs mounted on the contact terminals 16. The coil springs would then be squeezed together between the contact terminals 16 and the interior bottom of the main body part 18 upon assembly thereby creating the needed bias between the contact terminals 16 and the receiver terminals 17. However this solution is less desirable than the preferred embodiment, because it would be considerably less stable and more fragile as the terminals 16 would be unsupported except for the coil springs, as opposed to the preferred embodiment.

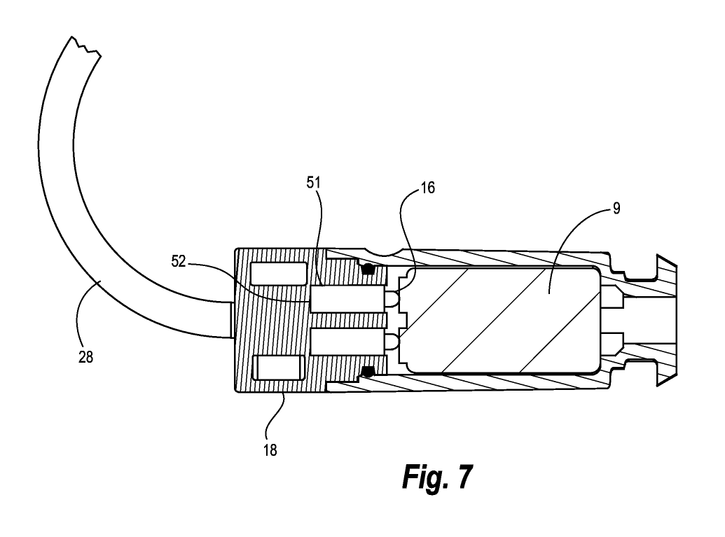

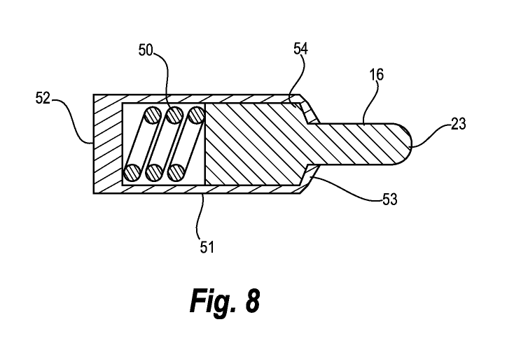

According to another embodiment of the invention shown in FIGS. 7 and 8, the elongated contact pin 16 further comprises a spring means 50 and an outer tubular element 51 adapted for sliding contact with an outer circumferential surface of the contact pin 16 such that preferably all of the spring means 50 and part of the contact pin 16 is concealed within the tubular element 51. Preferably the inner diameter of the outer tubular element 51 substantially equals, or is slightly larger than, the outer diameter of the contact pin 16. The outer tubular element may further comprise a closed end 52 opposite the end 23 of the contact pin 16. In this case the closed end 52 of the outer tubular element should preferably be made of an electrically conductive material.

The spring means 50 could for example be mounted on the elongated contact pin 16, be placed in extension of the contact pin 16 or constitute an intermediate section between to halves of the contact pin 16. In at least the latter two of these embodiments the spring means 50 should obviously be made of an electrically conductive material, preferably the same material as the contact pin.

Upon assembly the contact pin 16 would then be pressed into the outer tubular element 51 thereby squeezing together the spring means 50 between the contact pin 16 and the interior bottom of the main body part 18, between the contact pin 16 and the closed end 52 of the tubular element 51, or alternatively between the respective end parts of the contact pin 16, depending on the specific embodiment, thereby creating the needed bias between the contact terminals 16 and the receiver terminals 17. In this connection the outer tubular element 51 serves to support the contact pin 16 and spring means 50 preventing undesired radial displacements of the contact pin 16 and the spring means 50, the supporting effect being improved further in the case of the presence of a closed end 52. As shown in FIG. 7, in this embodiment it would furthermore be possible to omit the previously described spring element 15.

The tubular element 51, or at least the closed end 52 of the tubular element 51, and the spring means 50 may be made of any suitable electrically conductive material, but are preferably of the same material as the contact terminal. Hence the spring means 50 may be any kind of metallic spring, such as a metallic coil spring.

In a further preferred embodiment the contact pin 16 comprises a flange 54, preferably situated approximately at the middle of the length of the contact pin 16, and the tubular element 51 comprises at its end opposite the closed end 52 a narrowing 53. The flange 54 extends radially outwards from at least part of a circumference of the elongated contact pin 16. The flange 54 retains the contact pin 16 such that it may not extend out of the tubular element 51 beyond the point of contact between flange 54 and narrowing 53, thus preventing the contact pin 16 from falling out of the outer tubular element 51.

In a particularly preferred embodiment such a contact pin is a so-called pogo pin, that is marketed for instance by Molex Inc. of Lisle, Ill.

With a contact pin 16 comprising an outer tubular element 51 as described above it is in a preferred embodiment of the RITE-connector according to the invention as shown in FIG. 7 possible to mould the main body part 18 directly around the outer tubular element 51 of the contact terminal without interfering with the biasing effect of the spring means 50 as it is concealed within the tubular element 51. In this connection the presence of a closed end 52 of the tubular element 51 would serve to prevent moulding material from entering the tubular element 51 during moulding of the main body part 18.

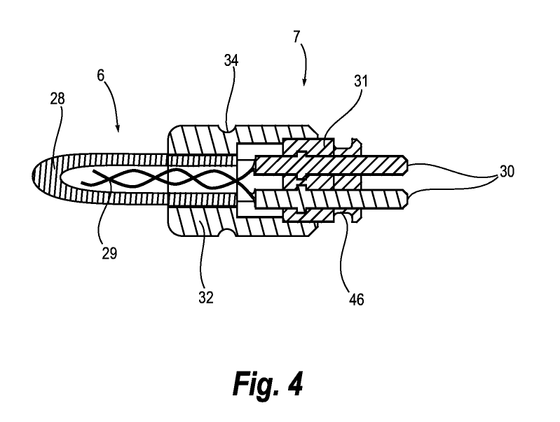

A detailed cross-sectional view of the coupling between fixture 5 and receiver 9 and of the receiver and receiver housing assembly is shown in FIG. 3, where the parts are assembled. In particular FIG. 3 shows a preferred embodiment of the electrically conductive means 6, in which the electrically conductive means 6 comprises tubing 28 enclosing a twisted wiring 29 that is connected—e.g. soldered or glued with conductive adhesive—to the contact terminals 16 inside the main body part 18 of the fixture 5 in an electrically conductive manner. The length of the wiring 29 is adapted to provide the excess wiring compared to the length of the tubing 28 needed to enable both the above mentioned connection with the contact terminals 16 in one end and the corresponding connection in the other end to contact pins 30 in a coupling means 7 shown in FIG. 4. The electrically conductive means 6 may be composed of any suitable conducting twisted or untwisted wiring that is sufficiently insulated, e.g. a twisted or untwisted wiring embedded in an insulating material. Referring to FIG. 2, the tubing 28 is secured to the fixture 5 through a hole 44 in the main body part 18, and to the coupling means 7 through a hole 45 in the contact casing 32.

It should be noted that the above embodiment with wiring 29 inside tubing 28 is only a preferred embodiment. The skilled person will realise that instead, the wiring 29 could be insertion moulded into a suitable material to form the electrically conductive means 6, and that instead of wiring 29 other electrically conductive elements, such as strips, could be used.

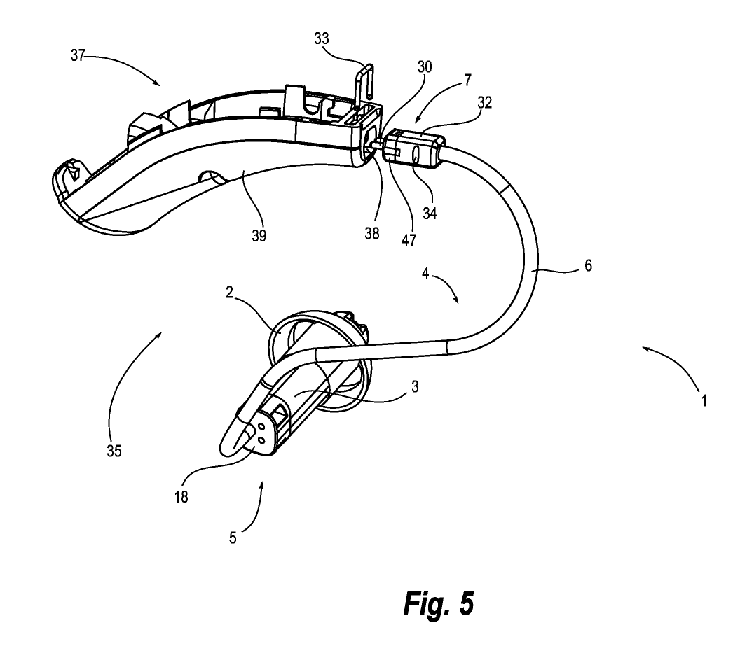

With reference, again, to FIG. 2, the RITE component 1 comprises a coupling means 7 to couple the RITE component 1 to a BTE housing component (not shown in FIG. 2). The coupling means 7 comprises at least one standard contact pin 30 adapted to engage with a corresponding female contact on the BTE housing component, and a contact receptacle 31 in which the contact pin 30 is mounted. The contact receptacle 31 comprises a circumferential indentation 46 adapted to secure a contact receptacle cover 47 (shown in FIG. 5) over the part of the contact receptacle that is protruding from the contact casing 32.

FIG. 4 shows a detailed cross-sectional view of the coupling means 7 in the assembled state. As can be seen, the contact pins 30 are connected to the wiring 29 of the electrically conductive means 6, and the contact pins 30 are furthermore mounted extending through the contact receptacle 31. The contact pins 30 are preferably connected to the wiring 29 by means of soldering, conductive adhesive or any other suitable means known to a person skilled in the art for making an electrically conductive connection.

According to a preferred embodiment the coupling means 7 further comprises a contact casing 32 that is adapted to interlock with a locking means located entirely inside of the BTE housing component. According to a particularly preferred embodiment, shown in FIG. 5, the locking means comprises a fixation spring 33, and the contact casing 32 comprises a recess 34 adapted for accommodating the fixation spring 33, such that the fixation spring 33 may engage with the recess 34 by its own elastic properties.

In FIG. 5, the fixation spring 33 is shown separated from an opened BTE housing component 37. The fixation spring 33 as shown comprises a simple two-legged clamp made of a suitable durable yet resilient material such as spring steel. However, the fixation spring 33 may also be of another construction or be any other releasable fixation means such as a screw. The actual appearance of the fixation spring 33 is of less importance as it is preferably hidden from sight by being located completely inside the BTE housing component 37.

The RITE component 1 is coupled together with the BTE housing component 37 by inserting the contact pins 30 of the coupling means 7 into the corresponding contact outlets (not shown) inside an opening 38 of the BTE housing component 37, then bringing the fixation spring 33 to engage the recess 34 of the coupling means 7 inside the BTE-component 37. By locating this coupling completely inside a BTE housing component casing 39 it is ensured that the BTE housing component 37 will under no circumstances inadvertently be loosened from the connector 4.

FIG. 6 shows a complete hearing aid system 40 according to the present invention. The hearing aid system 40 comprises a Behind-The-Ear (BTE) housing component 37, to which there is attached a Receiver-In-The-Ear (RITE) component 1. The electronics of the hearing aid system 40, including digital circuitry and battery, etc. but not the sound producing parts, is located inside of the BTE housing component 37. The sound producing parts, viz. a receiver 9, is not visible in FIG. 6, as they are located inside of a receiver housing 3 forming part of the RITE component 1.

In this respect it should be noted that the RITE component 1 as such may be used with both a left ear and a right ear, as this is merely a matter of shaping the electrically conductive means 6 accordingly.

Moreover it should be noted that the above description of preferred embodiments is merely an example, and that the skilled person would know that numerous variations are possible without departing from the scope of the claims.

1. A receiver-in-the-ear (RITE) component for a hearing aid, said RITE component comprising,
a receiver,
a receiver housing,
a connector, said connector having coupling means for coupling to a BTE housing component of said hearing aid, and an electrically conductive means, a fixture to connect the receiver in the receiver housing and the connector, said fixture having a spring element and at least two contact terminals adapted for abutting contact with corresponding contact terminals on said receiver.

2. The RITE component as claimed in claim 1, wherein said fixture comprises a main body part, and wherein said main body part and said receiver housing comprise respective and mutually engaging locking means adapted to lock said fixture and said receiver housing together.

3. The RITE component as claimed in claim 2, wherein said locking means in respect of said main body part comprises projecting means, and wherein said locking means in respect of said receiver housing comprises engagement means adapted for engagement with said projecting means.

4. The RITE component as claimed in claim 3, wherein said engagement means in respect of said receiver housing comprises at least one through hole between an inner surface of said receiver housing and an outer surface of said receiver housing.

5. The RITE component as claimed in claim 4, wherein said through holes in said receiver housing are located between the inner surface and an outer circumferential indentation adapted to accommodate a receiver sealing.

6. The RITE component according to claim 1, wherein at least one of said two contact terminals comprises an elongated contact pin, one end of which being adapted for said abutting contact with a respective receiver terminal.

7. The RITE component according to claim 6, wherein at least one of said elongated contact pins comprises a spring means, and an outer tubular element adapted for sliding contact with an outer circumferential surface of the elongated contact pin.

8. The RITE component as claimed in claim 7, wherein said outer tubular element comprises a closed end opposite the end of the contact pin adapted for said abutting contact with the receiver terminal.

9. The RITE component as claimed in claim 7, wherein said contact pin comprises a flange, and said outer tubular element comprises a narrowing at an end near the end of the contact pin adapted for said abutting contact with the receiver terminal.

10. The RITE component as claimed in claim 7, wherein at least one of said main body part of said fixture is moulded around said outer tubular element of said elongated contact pin.

11. The RITE component as claimed in claim 7, wherein at least one of said spring means, said outer tubular element and said closed end of said outer tubular element consists of an electrically conductive material.

12. The RITE component as claimed in claim 7, wherein at least one of said contact pins comprises a pogo pin.

13. The RITE component as claimed in claim 6, wherein said receiver housing comprises an open end adapted for the insertion of said fixture in an insertion direction, and wherein said elongated, contact pin extends essentially in parallel with said insertion direction.

14. The RITE component as claimed in claim 6, wherein said elongated contact pin is embedded in a resilient material adapted for biasing said contact pin into said abutting contact with said receiver terminal.

15. The RITE component as claimed in claim 1, wherein said at least two contact terminals of said fixture comprise gilt nickel silver.

16. The RITE component as claimed in claim 1, wherein said coupling means comprises a contact casing, said contact casing being adapted to interlock with a BTE housing locking means located entirely inside of said BTE housing component.

17. The RITE component as claimed in claim 16, wherein said BTE housing locking means comprises a fixation spring, and said contact casing comprises a recess adapted for accommodating said fixation spring.

18. A hearing aid comprising a RITE component and a BTE housing component, said RITE component having
a receiver;
a receiver housing;
a connector; and
a fixture;
said receiver including receiver contact terminals,
said connector including coupling means for coupling to said BTE housing component, and an electrically conductive means,
said fixture having a spring element and at least two fixture contact terminals adapted for abutting contact with said receiver contact terminals, and
said fixture being adapted to connect said receiver and said connector.

19. A method of connecting a receiver to a Behind-the-Ear (BTE) housing component of a hearing aid of the Receiver-in-the-Ear (RITE) type, comprising
providing the receiver with receiver contact terminals;
inserting the receiver in a receiver housing;
providing a connector with electrically conductive means and with coupling means for coupling to the BTE housing component;
providing a fixture with a spring element and at least two fixture contact terminals,
connecting the fixture to the connecting element;
abutting the fixture contact terminals into contact with the receiver contact terminals; and
locking the fixture and the receiver housing together.
